(19) United States
(12) Patent Application Publication
(10) Pub. No.: US 2024/0408989 A1
(43) Pub. Date: Dec. 12, 2024

(54) CONTAINERS FOR ELECTRIC VEHICLE CHARGING STATIONS

(71) Applicant: Paul W. Gordon, Hernando, MS (US)

(72) Inventor: Paul W. Gordon, Hernando, MS (US)

(21) Appl. No.: 18/207,809

(22) Filed: Jun. 9, 2023

Related U.S. Application Data
(60) Provisional application No. 63/351,187, filed on Jun. 10, 2022.

(51) Int. Cl. B60L 53/50; B60L 53/14; B60L 53/30

(52) U.S. Cl. CPC B60L 53/50; B60L 53/14; B60L 53/305

(57) ABSTRACT

A container for distributing electrical current from an electrical current source to at least one electric vehicle charging station at an electric vehicle charging facility may include a transportable container enclosure having an enclosure interior and an enclosure exterior. An electrical distribution system may be provided in the enclosure interior of the container enclosure. The electrical distribution system may be configured for electrical communication with the electrical current source and the at least one electric vehicle charging station. The electrical distribution system may have at least one charging station transformer configured to step up voltage of the electrical current from the electrical current source and transmit the electrical current to the at least one electric vehicle charging station. Methods of stepping up voltage of electrical current from an electrical current source to electric vehicle service equipment having at least one electric vehicle charging station at an electric vehicle charging facility are also disclosed.

### CROSS-REFERENCE TO RELATED APPLICATIONS

This application claims the benefit of U.S. provisional application No. 63/351,187, filed Jun. 10, 2022, and entitled CONTAINERS FOR ELECTRIC VEHICLE CHARGING STATIONS, which provisional application is hereby incorporated by reference herein in its entirety.

### FIELD

Illustrative embodiments of the disclosure relate to electric vehicle charging stations for electrically charging electric vehicles at an electric vehicle charging facility. More particularly, illustrative embodiments of the disclosure relate to containers which house an electrical distribution system that distributes electrical current from a source of electrical current electrical current source to one or more electrical vehicle charging stations at an electric vehicle charging facility and are highly customizable depending on the needs or specifications of the charging facility and can be manufactured off-site and readily transported to and installed at the facility.

### SUMMARY

Illustrative embodiments of the disclosure are generally directed a container for distributing electrical current from a source of electrical current to at least one electric vehicle charging station at an electric vehicle charging facility. An illustrative embodiment of the container may include a transportable container enclosure having an enclosure interior and an enclosure exterior. An electrical distribution system may be provided in the enclosure interior of the container enclosure. The electrical distribution system may be configured for electrical communication with the source of electrical current and the at least one electric vehicle charging station. The electrical distribution system may have at least one charging station transformer configured to step up voltage of the electrical current from the electrical current source and transmit the electrical current to the at least one electric vehicle charging station.

Illustrative embodiments of the disclosure are further directed to methods of stepping up voltage of electrical current from an electrical current source to electric vehicle service equipment having at least one electric vehicle charging station at an electric vehicle charging facility. An illustrative embodiment of the method may include fabricating a container at a manufacturing facility by constructing a container enclosure having an enclosure interior and an enclosure exterior; assembling an electrical distribution system in the enclosure interior of the container enclosure, the electrical distribution system configured for electrical communication with the electrical current source and the at least one electric vehicle charging station, the electrical distribution system having at least one charging station transformer configured to step up voltage of the electrical current and transmit the electrical current to the at least one electric vehicle charging station; transporting the container to the electric vehicle charging facility; placing the container enclosure at a desired location of the electric vehicle charging facility: electrically connecting the at least one charging station transformer of the electrical distribution system to the electrical current source; and electrically connecting the at least one vehicle charging station of the electric vehicle charging facility to the at least one charging station transformer of the electrical distribution system.

### BRIEF DESCRIPTION OF THE DRAWINGS

Illustrative embodiments of the disclosure will now be described, by way of example, with reference to the accompanying drawings, in which:

FIG. 1 is a schematic wiring diagram of an illustrative embodiment of the containers for electric vehicle charging stations, with a typical electrical distribution system inside a container enclosure of the container electrically interfacing with an electrical current source and vehicle charging stations at an electric vehicle charging facility;

FIG. 2 is a top view of a typical container enclosure of an illustrative embodiment of the containers;

FIG. 3 is a sectioned top view of a typical electric vehicle charging facility at a business establishment building and having a parking lot with multiple parking spaces adjacent to the building and electrical vehicle service equipment (EVSE) with multiple vehicle charging stations adjacent to the parking spaces, with the container placed between the building and the parking spaces and electrically interfacing with an electrical current source and with the electrical vehicle service equipment in typical application of the containers;

FIG. 4 is a sectioned top view of another electric vehicle charging facility in typical application of the containers;

FIG. 5 is a perspective view of a typical container enclosure of an illustrative embodiment of the containers for electric vehicle charging stations;

FIGS. 6-9 are schematic wiring diagram top views illustrating typical lighting control systems for a four-station, two-station, one-station and one-station EVSE, respectively;

FIGS. 10-13 are schematic wiring diagram top views illustrating typical electrical distribution systems for the four-station, the two-station, the one-station and the one-station EVSE, respectively;

FIGS. 14-16 are schematic wiring diagram top views illustrating typical alternative lighting control systems for a six-station or less, three-station or less and a two-station EVSE, respectively;

FIGS. 17-19 are schematic wiring diagram top views illustrating typical alternative electrical distribution systems for the six-station or less, the three-station or less and the two-station EVSE, respectively;

FIGS. 20-26 illustrate typical main breaker panels for various embodiments of the containers;

FIG. 27 is an enlarged schematic wiring diagram of the illustrative container illustrated in FIG. 1;

FIG. 28 is an enlarged front view of the EVSE having the four vehicle charging stations of the electric vehicle charging facility illustrated in FIG. 1:

FIG. 29 is an enlarged schematic wiring diagram of the lighting control system of the illustrative container in top view, illustrated in FIG. 6; and

FIG. 30 is an enlarged schematic wiring diagram of the electrical distribution system of the illustrative container illustrated in top view, illustrated in FIG. 10.

### DETAILED DESCRIPTION

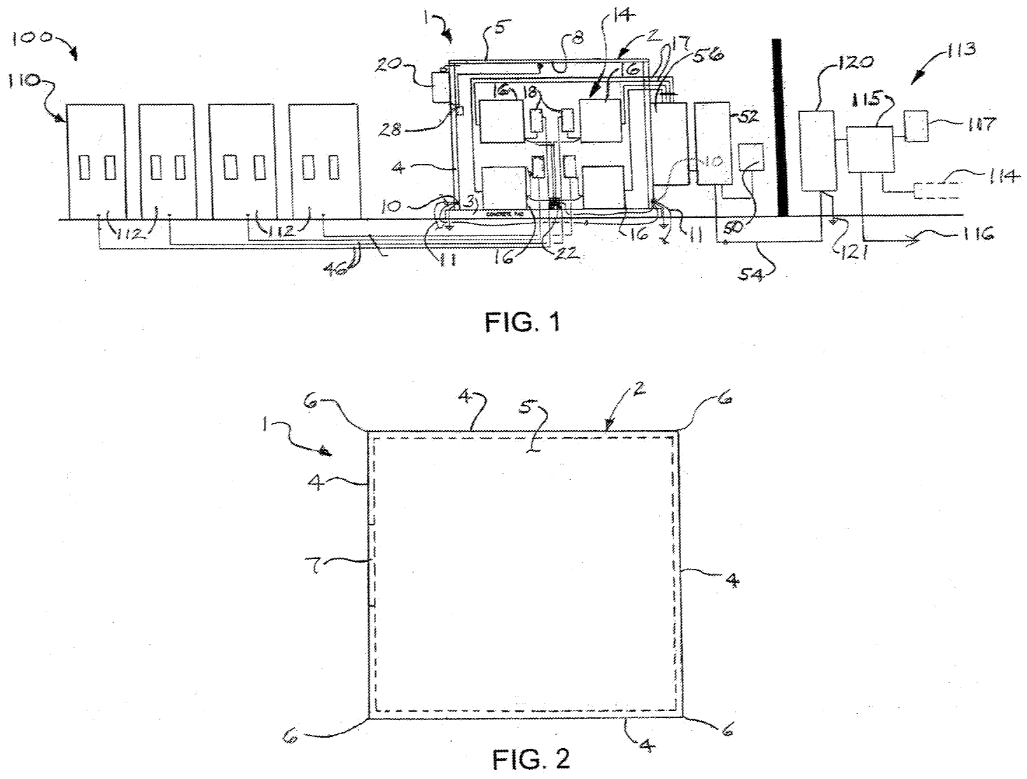

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”. “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring initially to FIGS. 1-5 of the drawings, an illustrative embodiment of the containers for electric vehicle charging stations, hereinafter container, is generally indicated by reference numeral 1. As illustrated in FIG. 1, in typical application, which will be hereinafter described, the container 1 may house an electrical distribution system 14 that steps up voltage of an electrical current and distributes the current from an electrical current source 114 of an electrical riser 113 to one or more electrical vehicle charging stations 112 at an electric vehicle charging facility 100. The container 1 is highly customizable depending on the needs or specifications of the charging facility 100 and can be manufactured off-site and readily transported to and installed at the facility 100. The container 1 can be customized to accommodate at least one and up to six or more of the vehicle charging stations 112. The electrical riser 113 at the electric vehicle charging facility 100 may provide electrical current in a 208Y/120V, 3PH-4W configuration. The electrical current source 114 may include a service lateral, a circuit breaker, and/or fuse disconnect switch or panel board inside a building, for example and without limitation, and/or any other suitable source of electrical current which may be available.

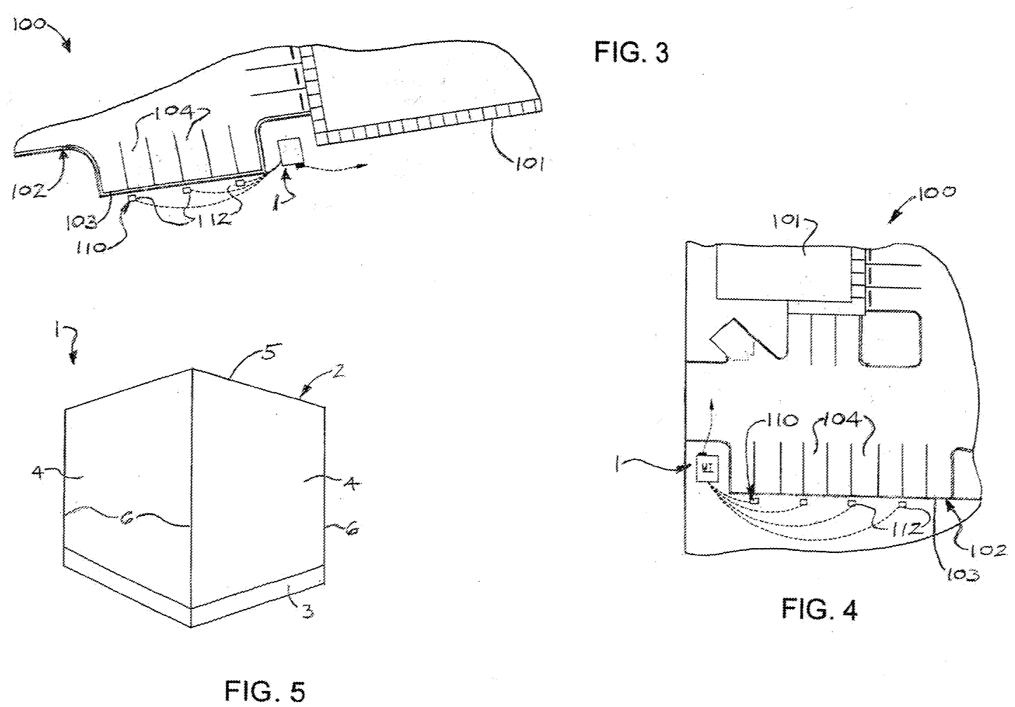

As illustrated in FIGS. 3 and 4, in some applications, the electric vehicle charging facility 100 may be located adjacent to a business establishment building 101. For example and without limitation, in some applications, the business establishment building 101 may include a hotel, restaurant, service station or retail establishment. A parking lot 102 having multiple parking spaces 104 may be adjacent to the building 101. Electrical vehicle service equipment (EVSE) 110, having at least one, and typically, multiple vehicle charging stations 112, may be adjacent to the parking spaces 104, typically along a parking lot edge 103 of the parking lot 102. The container 1 may be placed in the vicinity of the vehicle charging stations 112, typically between the building 101 and the parking spaces 104 on the parking lot 102, and placed into electrical interface with an electrical current source 114 (FIG. 1) at the electrical riser 113 and with the EVSE 110. Accordingly, the electrical distribution system 14 in the container 1 may receive the electrical current via the electrical current source 114, step up the voltage of the electrical current and transmit the electrical current with the necessary voltage to the vehicle charging stations 112 for charging of electrical vehicles at the vehicle charging stations 112.

As illustrated in FIGS. 2 and 5, the container 1 may include a container enclosure 2. In typical installation of the container 1 at the electric vehicle charging facility 100, the container enclosure 2 may be placed on an enclosure pad 3. The enclosure pad 3 may be fabricated of concrete, for example and without limitation, and/or any other material with sufficient density and strength to support the weight of the container enclosure 2 and the components of the electrical distribution system 14.

Multiple enclosure sidewalls 4 may extend upwardly from the enclosure pad 3. In some embodiments, the container enclosure 2 may be cuboid with four enclosure sidewalls 4 of equal length and height. In other embodiments, the container enclosure 2 may be elongated and rectangular or may have alternative shapes with any number of enclosure sidewalls 4. Enclosure corners 6 may be formed where the adjacent enclosure sidewalls 4 meet. An enclosure top 5 may be provided on the enclosure sidewalls 4. As illustrated in FIG. 1, an enclosure interior 8 may be formed by the enclosure pad 3, the enclosure sidewalls 4 and the enclosure top 5 of the container enclosure 2. As illustrated in FIG. 2, at least one enclosure door 7 may be provided in at least one of the enclosure sidewalls 4 of the container enclosure 2. The enclosure sidewalls 4 and the enclosure top 5 of the container enclosure 2 may include metal, plastic, composite materials, other materials, or combinations thereof. The container enclosure 2 of the container 1 may be seismic for earthquake-prone areas, or non-seismic, depending on the geographical area in which the container 1 is deployed.

As illustrated in FIG. 1, multiple ground rods 10 may be attached to the enclosure sidewalls 4 of the container enclosure 2. In some embodiments, the ground rods 10 may be attached to the respective enclosure corners 6 of the container enclosure 2. A ground ring 11 may connect the adjacent ground rods 10 to each other. In the installed container 1, the ground ring 11 may be buried beneath the ground around or beneath the enclosure pad 3 at a depth of typically about 30″, for example and without limitation. Accordingly, the ground ring 11 may provide electrical grounding for the container enclosure 2 of the installed container 1.

As further illustrated in FIG. 1, at the electric vehicle charging facility 100, a current transformer cabinet 115 may electrically interface with the electrical current source 114. An electric service upgrade pathway 116 may interface with the current transformer cabinet 115. The electric service upgrade pathway 116 may provide the option of upgrading the voltage, amperage, etc. of the electrical current which is supplied through the electrical current source 114.

An electric meter 117 may electrically interface with the current transformer cabinet 115. The electric meter 117 may be configured to indicate the electrical current expenditure of the EVSE 110 typically in the conventional manner.

A main disconnect switch 120, typically having a ground 121, may electrically interface with the current transformer cabinet 115. The main disconnect switch 120 may facilitate selective termination of electrical current from the current transformer cabinet 115 to the electrical distribution system 14 in the enclosure interior 8 of the container enclosure 2. In some embodiments, the main disconnect switch 120 may have an 800A/3P/800AF operational configuration, for example and without limitation.

An electrical generator 50 may interface with the main disconnect switch 120 typically through a transfer switch 52, via an electrical conduit 54. The electrical generator 50 may facilitate selective generation of electrical current in the event that a power failure prevents service of current from the electrical current source 114. The transfer switch 52 may facilitate selective transfer of the electrical current pathway from the electrical current source 114, via the main disconnect switch 120, to the electrical generator 50. In some embodiments, the transfer switch 52 may be an automatic transfer switch (ATS) having an 800A 3-pole NEMA 3R 208Y/120V, 3PH-4W operational configuration, for example and without limitation.

In some embodiments, the electrical generator 50 and the transfer switch 52 may be provided in a generator enclosure (not illustrated). The generator enclosure may be attached to the container enclosure 2 via a using a channel support strut system, bolts, brackets and/or other attachment mechanism known by those skilled in the art (not illustrated). In other embodiments, the generator enclosure may be provided as a stand-alone structure from the container enclosure 2.

A main breaker panel 56 may electrically interface with the transfer switch 52. The electrical distribution system 14 in the container enclosure 2 of the container 1 may electrically interface with the main breaker panel 56. In some embodiments, the main breaker panel 56 may have a 208Y/120V. 3PH-4W operational configuration, for example and without limitation.

As further illustrated in FIG. 1, the EVSE 110 may include at least one vehicle charging station 112. In some embodiments, the EVSE 110 may have six or more vehicle charging stations 112. Each vehicle charging station 112 may electrically interface with the electrical distribution system 14 via an electrical conduit 46.

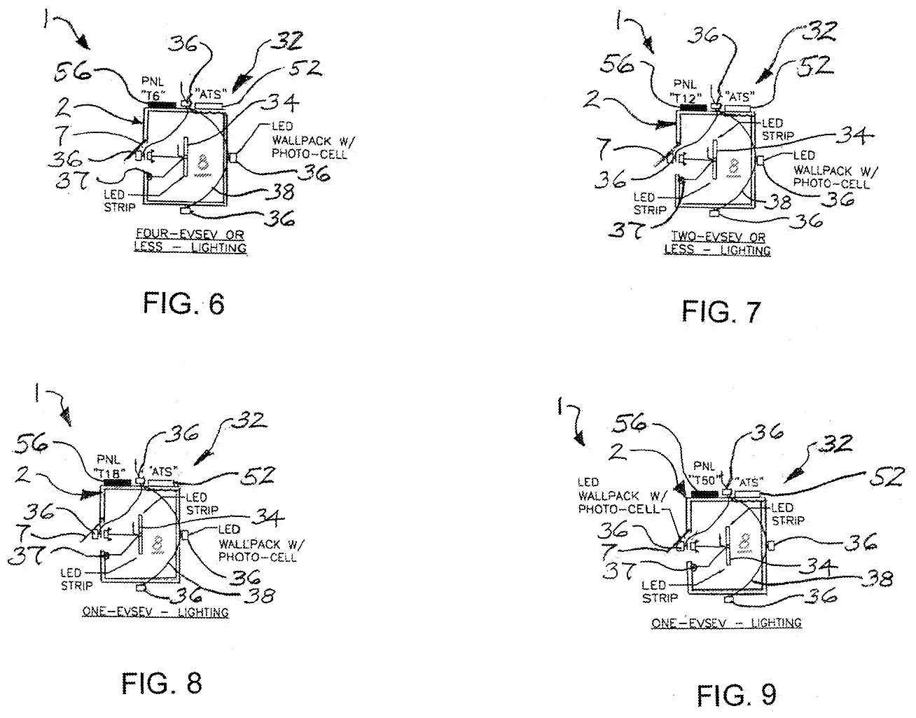

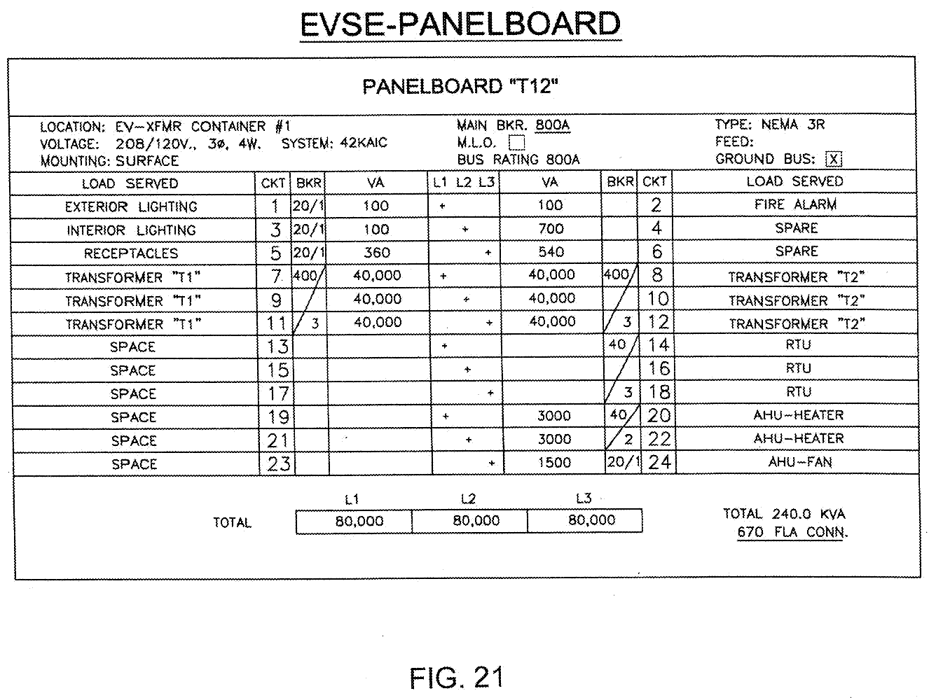

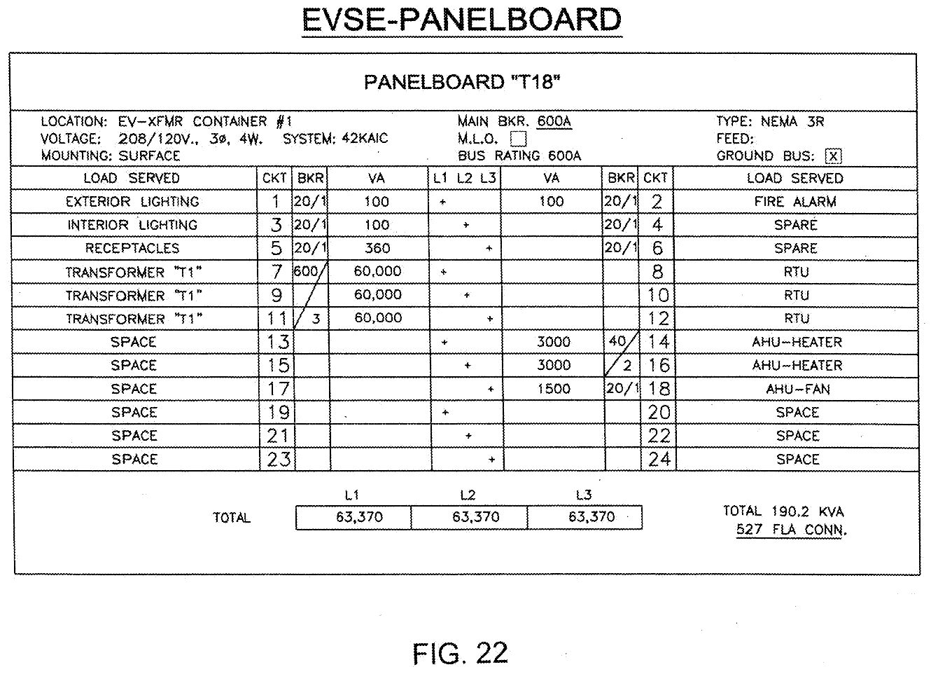

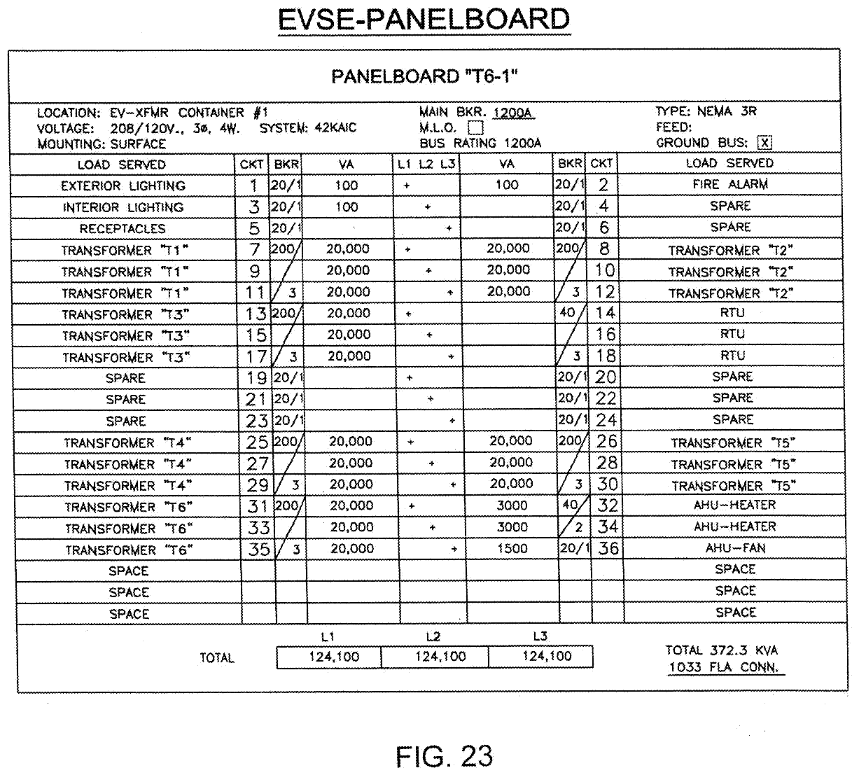

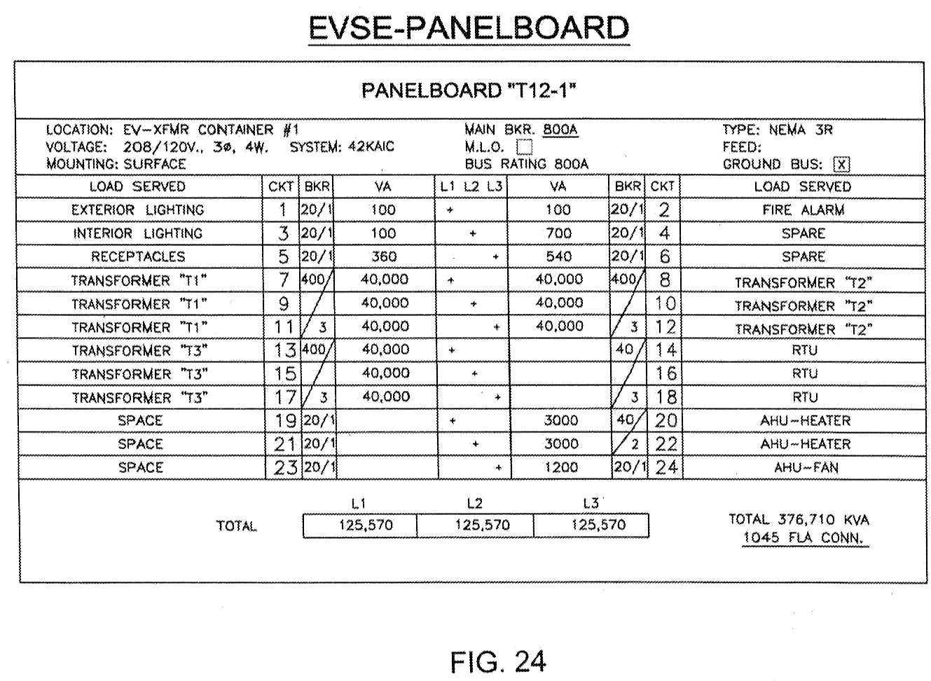

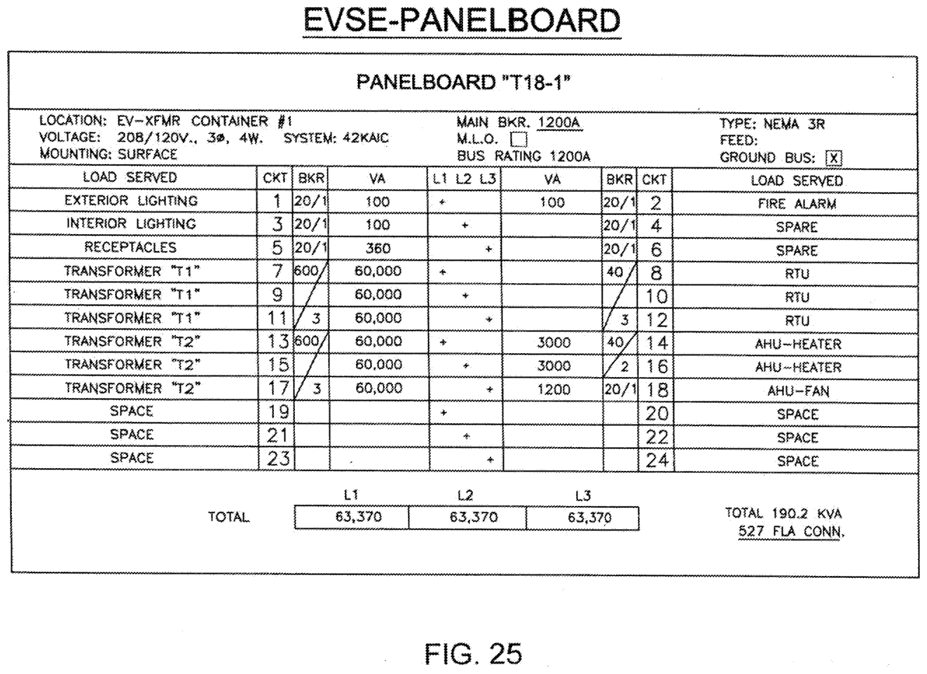

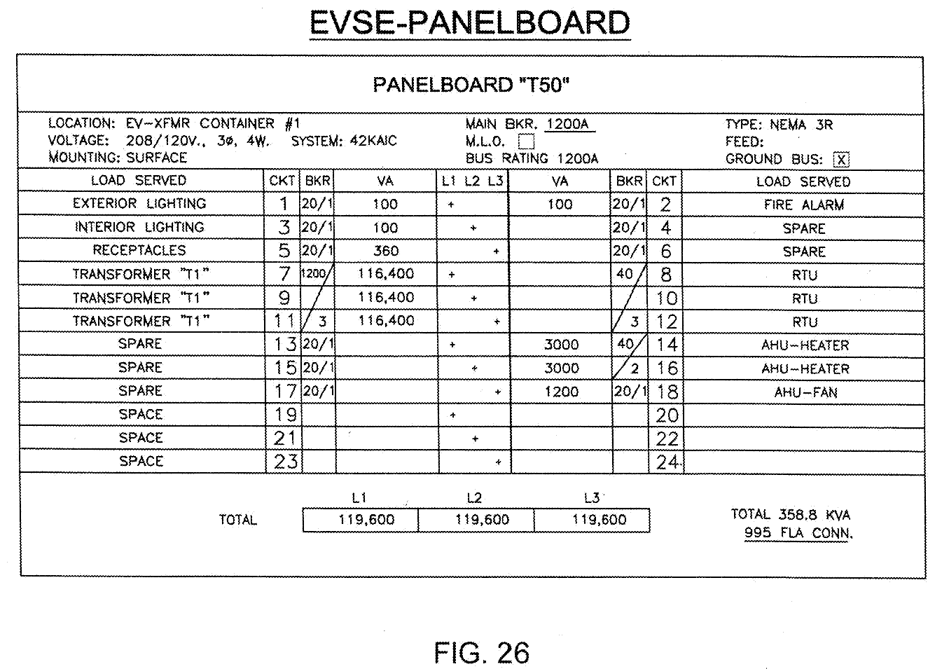

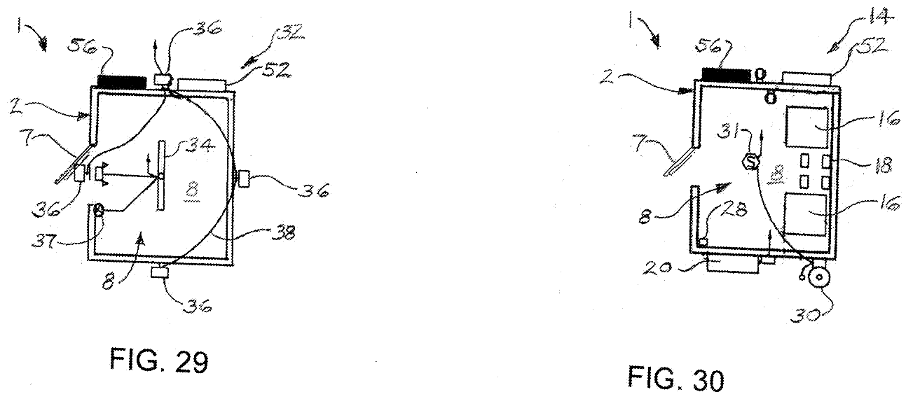

Referring next to FIGS. 6-30 of the drawings, various details and components of the electrical distribution system 14 and a typical lighting control system 32 suitable for illuminating the enclosure interior 8 and/or enclosure exterior of the container enclosure 2 are illustrated. Exemplary lighting control systems 32 are illustrated in FIGS. 6-9, 14-16 and 29. As illustrated in FIGS. 6 and 29, for an EVSE 110 having four or fewer vehicle charging stations 112, the lighting control system 32 of the container 1 may include at least one enclosure lamp 34 in the enclosure interior 8. In some embodiments, each enclosure lamp 34 may include at least one LED strip, for example and without limitation. In some embodiments, at least one enclosure lamp 34 may be provided on the interior surface of the enclosure top 5 of the container enclosure 2. One or more enclosure lamps 34 may additionally or alternatively be provided on the interior surfaces of one or more of the enclosure sidewalls 4 and/or on the exterior surfaces of the enclosure sidewall or sidewalls 4.

At least one lamp control module 36 may be provided on an exterior surface of the container enclosure 2. Each lamp control module 36 may controllably interface with each enclosure lamp 34 according to the knowledge of those skilled in the art, such as via suitable electrical wiring 38, for example and without limitation. In some embodiments, each lamp control module 36 may include a wall pack with a photocell. Accordingly, each wall pack may include a manual switch to facilitate selective energizing of the enclosure lamp 34 and illumination of the enclosure interior 8. Each wall pack may additionally or alternatively include the photocell, which may be configured to energize the enclosure lamp 34 responsive to darkening of the ambient environment of the container 1.

Any number of lamp control modules 36 may be provided on the container enclosure 2. For example and without limitation, in some embodiments, a lamp control module 36 may be provided on the exterior surface of each enclosure sidewall 4 of the container enclosure 2. In some embodiments, a lamp control module 36 may additionally or alternatively be provided on the interior surface of the enclosure door 7. Accordingly, the lamp control module 36 may be configured to energize the enclosure lamp 34 upon opening of the enclosure door 7. In some embodiments, a wall switch 37 may be provided on an interior surface of the enclosure sidewall 4 typically adjacent to the enclosure door 7. The wall switch 37 may controllably interface with the enclosure lamp 34. The wall switch 37 may facilitate selective manual actuation of the enclosure interior 8. The lighting control system 32 may include an occupancy sensor (not illustrated) in the enclosure interior 8. The occupancy sensor may controllably interface with the enclosure lamp 34. The occupancy sensor may be configured to energize the enclosure lamp 34 responsive to sensing the presence of personnel in the enclosure interior 8. The lighting control system 32 of the container 1 may include either or both exterior lighting components for illuminating the exterior of the container enclosure 2 and interior lighting components for illuminating the enclosure interior 8 of the container enclosure 2.

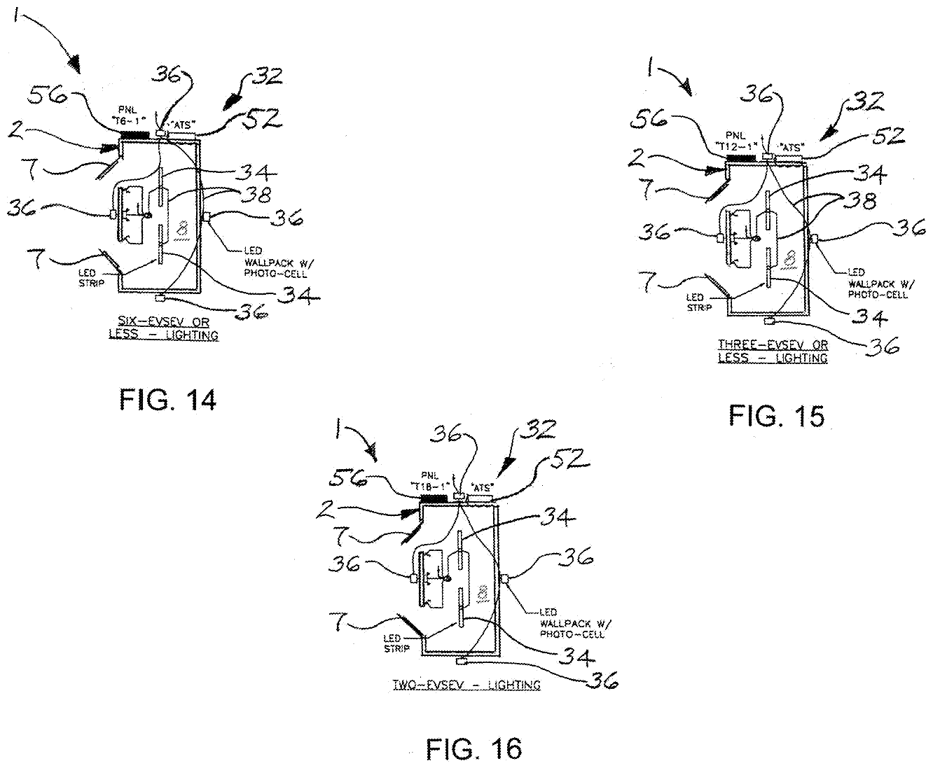

FIGS. 6-9 are schematic wiring diagrams illustrating typical lighting control systems 32 and arrangement of electrical components thereof for a container 1 suitable for a four-station or less EVSE 110 (FIG. 6), typically having a T6 main breaker panel 56; a two-station or less EVSE 110 (FIG. 7), typically having a T12 main breaker panel 56; a one-station EVSE 110 (FIG. 8), typically having a T18 main breaker panel 56; and an alternative one-station EVSE 110 (FIG. 9), typically having a T50 main breaker panel 56. FIGS. 14-16 are schematic wiring diagrams illustrating typical alternative lighting control systems 32 for a six-station or less EVSE 110 (FIG. 14), typically having a T6-1 main breaker panel 56; a three-station or less EVSE 110 (FIG. 15), typically having a T12-1 main breaker panel 56; and a two-station EVSE 110 (FIG. 16), typically having a T18-1 main breaker panel 56.

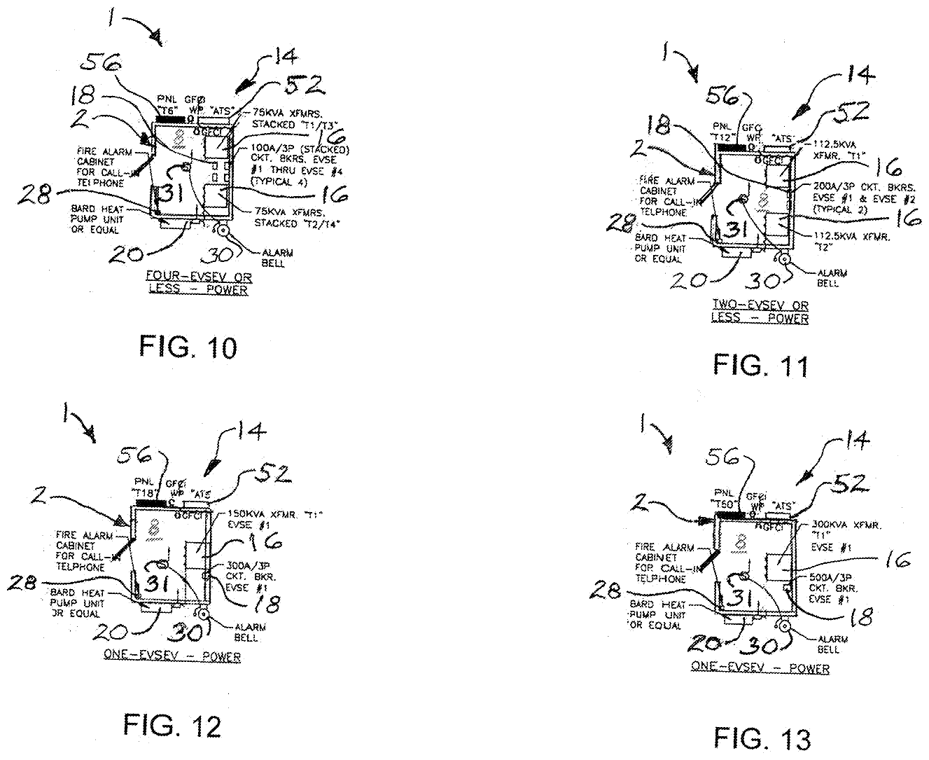

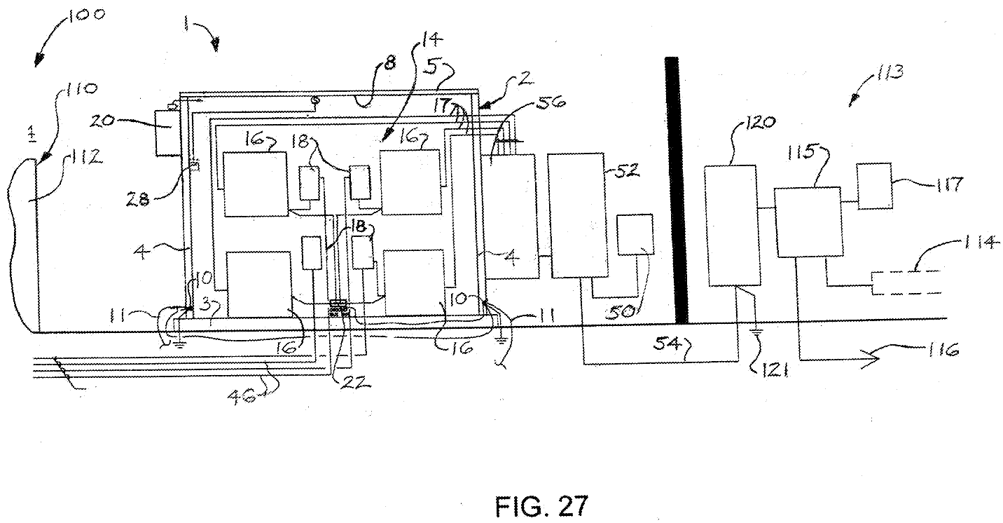

Exemplary electrical distribution systems 14 of the containers 1 are illustrated in FIGS. 10-13, 17-19, 27 and 30. As illustrated in FIGS. 10 and 30, for an EVSE 110 having four or fewer vehicle charging stations 112, the electrical distribution system 14 of the container 1 may include at least one charging station transformer 16 in the enclosure interior 8. The number of charging station transformers 16 may correspond to the number of vehicle charging stations 112 at the electrical vehicle charging facility 100, with each vehicle charging station 112 having its corresponding charging station transformer 16. As illustrated in FIG. 27, each charging station transformer 16 may electrically interface with the main breaker panel 56 through a corresponding electrical conduit 17. In some embodiments, each charging station transformer 16 may be a 480Y/277V, 3P-4W SEC, industrial step-up transformer which steps up the voltage of the incoming electrical current typically from 120 V to 480 V, for example and without limitation.

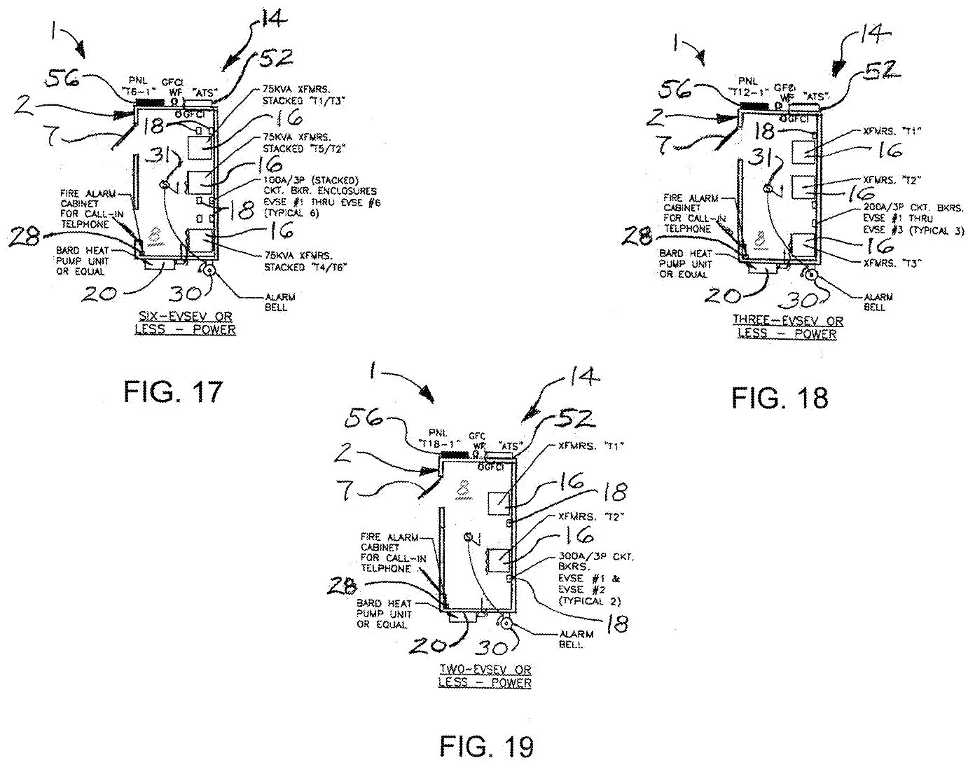

FIGS. 10-13 are schematic wiring diagrams illustrating typical electrical distribution systems 14 and arrangement of electrical components thereof for a container 1 suitable for a four-station or less EVSE 110 (FIG. 10) typically having the T6 main breaker panel 56; a two-station or less EVSE 110 (FIG. 11), typically having the T12 main breaker panel 56; a one-station EVSE 110 (FIG. 12), typically having the T18 main breaker panel 56; and an alternative one-station EVSE 110 (FIG. 13), typically having the TSO main breaker panel 56. FIGS. 17-19 are schematic wiring diagrams illustrating typical alternative electrical distribution systems 14 for a container 1 suitable for a six-station or less EVSE 110 (FIG. 17), typically having the T6-1 main breaker panel 56: a three-station or less EVSE 110 (FIG. 18), typically having the T12-1 main breaker panel 56; and a two-station or less EVSE 110 (FIG. 19), typically having the T18-1 main breaker panel 56.

As illustrated in FIG. 27, a ground bus bar 22 may electrically interface with each charging station transformer 16. The ground rods 10 may electrically interface with the ground bus bar 22. The ground bus bar 22 may be provided at the enclosure pad 3 of the container enclosure 2.

A transformer circuit breaker 18 may electrically interface with each charging station transformer 16. Each transformer circuit breaker 18 may be contained inside a corresponding circuit breaker enclosure. As further illustrated in FIG. 27, each charging station transformer 16 and/or each transformer circuit breaker 18 may electrically interface with the ground bus bar 22.

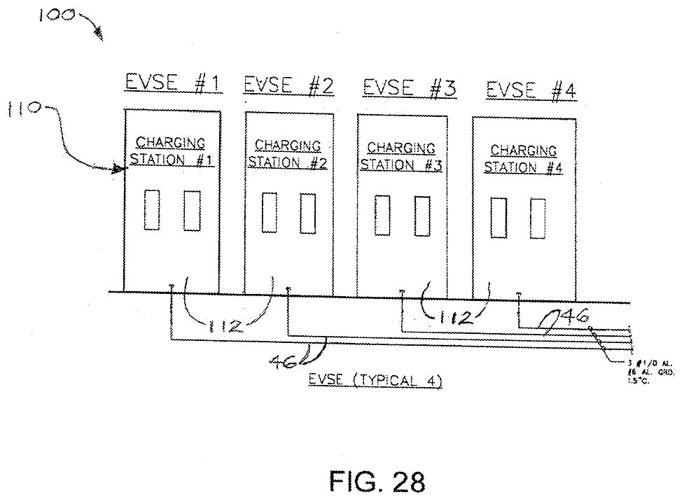

As illustrated in FIGS. 27 and 28, each vehicle charging station 112 of the electric vehicle charging facility 100 may electrically interface with its corresponding charging station transformer 16 via an electrical conduit 46. The electrical conduits 46 may extend through a pipe (not illustrated) which may be buried beneath the ground surface from the container 1 to the electric vehicle service equipment 110.

A heat pump 20 may be disposed in fluid communication with the enclosure interior 8 of the container enclosure 2. The heat pump 20 may facilitate heating and cooling of the enclosure interior 8, typically in the conventional manner. The heat pump 20 may be thermostat-controlled and/or manually controlled.

The heat pump 20 may be placed in any location or position on the container enclosure 2 which is suitable for the purpose. Accordingly, in some embodiments, the heat pump 20 may be mounted on one of the enclosure sidewalls 4 of the container enclosure 2, as illustrated. For example and without limitation, in some embodiments, the heat pump 20 may be an exterior wall mounted heat pump. In other embodiments, the heat pump 20 may be mounted on the enclosure top 5 or in any other suitable location on the container enclosure 2.

In some embodiments, a fire alarm cabinet 28 may be provided in the enclosure interior 8 of the container enclosure 2. A call-in telephone (not illustrated) may be provided in the fire alarm cabinet 28. The call-in telephone may be placed into communication with fire and/or other emergency services personnel for notification purposes. As illustrated in FIGS. 10-13 and 17-19, in some embodiments, the fire alarm cabinet 28 may be provided adjacent to the enclosure door 7 for ease of access.

As illustrated in FIGS. 10-13, in some embodiments, an alarm bell 30 may be provided on the exterior of the container enclosure 2. For example and without limitation, the alarm bell 30 may be provided on the exterior surface of one of the enclosure sidewalls 4. At least one alarm bell switch 31 may operably interface with the alarm bell 30 to facilitate selective actuation of the alarm bell 30. The alarm bell switch 31 may be provided in any suitable accessible location in and/or outside the enclosure interior 8, such as on the interior surface of one of the enclosure sidewalls 4, for example and without limitation.

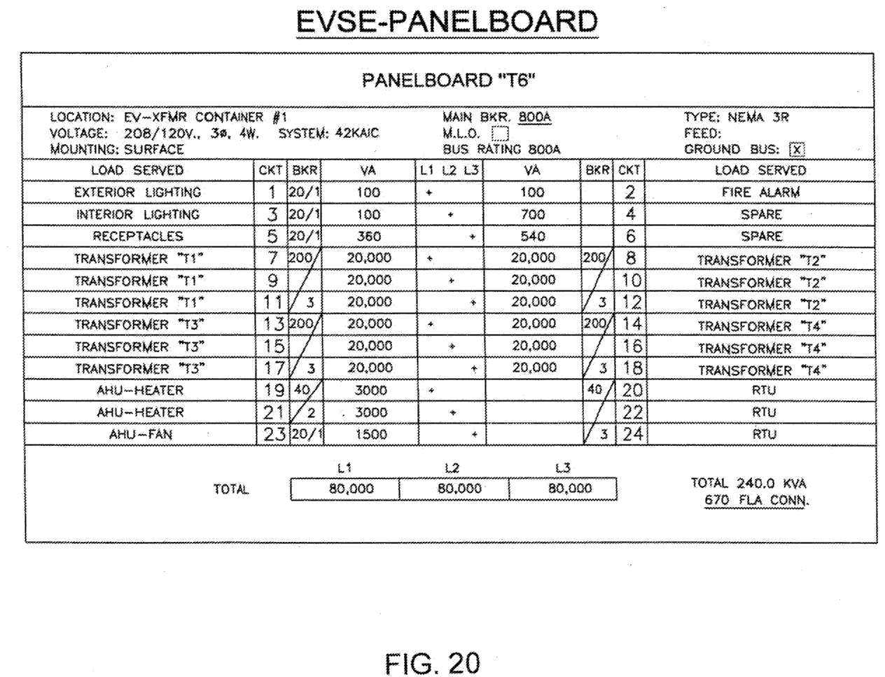

FIGS. 20-26 illustrate typical main breaker panels 56 suitable for various embodiments of the containers 1. Each main breaker panel 56 may include the load served for each component of the electrical distribution system 14 as well as the interior and exterior components of the lighting control system 32.

Referring again to FIGS. 1-5 of the drawings, in typical application, the container 1 may be fabricated at a suitable manufacturing facility by construction of the container enclosure 2 and assembly of the electrical distribution system 14 and lighting control system 32 in the enclosure interior 8. The fabricated and assembled container 1 may be transported to the electric vehicle charging facility 100. The enclosure pad 3 of the container enclosure 2 may be placed at the desired location of the electric vehicle charging facility 100, typically in the vicinity of the parking lot 102 or between the parking lot 102 and the business establishment building 101, as was heretofore described with respect to FIGS. 3 and 4.

The transfer switch 52 of the container 1 may be electrically connected to the main disconnect switch 120 of the electrical riser 113 typically via the electric conduit 54. In some applications, the electric conduit 54 may extend through a pipe (not illustrated) which may be buried beneath the ground surface from the main disconnect switch 120 to the transfer switch 52. The charging station transformers 16 in the enclosure interior 8 of the container enclosure 2 may be electrically connected to the main breaker panel 56 typically via the electrical conduits 17. The vehicle charging stations 112 of the electric vehicle charging facility 100 may be electrically connected to the respective charging station transformers 16 typically via the respective electrical conduits 46. In some applications, the electrical conduits 46 may extend through the pipe (not illustrated) which may be buried beneath the ground surface from the container 1 to the electric vehicle service equipment 110.

Electric vehicles (not illustrated) may be connected to the vehicle charging stations 112 for electrical recharging of the vehicles. Accordingly, electrical current (typically 120V) may be supplied from the electrical current source 114 through the current transformer cabinet 115, the main disconnect switch 120, the transfer switch 52 and the main breaker panel 56, respectively, to the charging station transformers 16 of the electrical distribution system 14. The charging station transformers 16 may step up the voltage of the incoming electrical current from 120 V to 480 V. The electrical current with the stepped-up voltage may be transmitted from the charging station transformers 16 to the respective vehicle charging stations 112, typically via the electrical conduit 46. At the vehicle charging stations 112, the electrical current recharges the batteries of the electric vehicles, typically in the conventional manner.

Under circumstances in which termination of electrical current to the electrical distribution system 14 is required, such as for maintenance, repair and/or replacement of any of the components of the electrical distribution system 14, the main disconnect switch 120 may be actuated for the purpose. In the event of a power failure, in which electrical current is not received via the electrical service lateral 114, the transfer switch 52 may be actuated to switch supply of electrical current from the electrical service lateral 114 to the electrical generator 50. The electrical generator 50 may thus be operated to supply the typically 120 V electrical current to the electrical distribution system 14 via the main breaker panel 56.

The lighting system 32 (FIGS. 36-39) of the container 1 may be operated to illuminate the interior and/or exterior of the container enclosure 2. The heat pump 20 may be operated to heat or cool the enclosure interior 8 of the container enclosure 2. Under circumstances in which there is a fire or other emergency at the electric vehicle charging facility 100, the fire alarm cabinet 28 may be accessed to notify fire and/or other emergency service personnel to the emergency. The alarm bell 30 (FIGS. 10-13) may be actuated typically by manipulation of the alarm bell switch 31 to notify personnel in the vicinity of the container 1 to the emergency.

While certain illustrative embodiments of the disclosure have been described above, it will be recognized and understood that various modifications can be made to the embodiments and the appended claims are intended to cover all such modifications which may fall within the spirit and scope of the disclosure.

What is claimed is:

1. A container for distributing electrical current from an electrical current source to at least one electric vehicle charging station at an electric vehicle charging facility, comprising:
a transportable container enclosure having an enclosure interior and an enclosure exterior; and
an electrical distribution system in the enclosure interior of the container enclosure, the electrical distribution system configured for electrical communication with the electrical current source and the at least one electric vehicle charging station, the electrical distribution system having at least one charging station transformer configured to step up voltage of the electrical current from the electrical current source and transmit the electrical current to the at least one electric vehicle charging station.

2. The container of claim 1 wherein the at least one charging station transformer is configured to step of the voltage of the electrical current from 120V to 480 V.

3. The container of claim 1 further comprising at least one ground bus bar electrically interfacing with the at least one charging station transformer, a plurality of ground rods on the container enclosure and electrically interfacing with the at least one ground bus bar, and a ground ring electrically connecting the plurality of ground rods to each other, the ground ring configured for burial to ground the container enclosure.

4. The container of claim 1 further comprising an alarm bell provided on the container enclosure and at least one alarm bell switch operably interfacing with the alarm bell to facilitate selective actuation of the alarm bell.

5. The container of claim 1 further comprising a lighting control system comprising at least one enclosure lamp configured to illuminate at least one of the enclosure interior and the enclosure exterior of the container enclosure.

6. The container of claim 5 further comprising at least one lamp control module on an exterior surface of the container enclosure, the lamp control module controllably interfacing with the at least one enclosure lamp.

7. The container of claim 6 wherein the at least one lamp control module comprises a wall pack with a photocell configured to energize the at least one enclosure lamp responsive to darkening of an ambient environment of the container enclosure.

8. The container of claim 7 wherein the wall pack comprises a manual switch to facilitate selective energizing of the at least one enclosure lamp and illumination of the enclosure interior.

9. The container of claim 1 further comprising a heat pump disposed in fluid communication with the enclosure interior of the container enclosure, the heat pump configured to facilitate heating and cooling of the enclosure interior.

10. The container of claim 1 further comprising a main breaker panel electrically interfacing with the electrical distribution system, the main breaker panel configured for electrical connection to the electrical current source.

11. The container of claim 10 further comprising a transfer switch electrically interfacing with the main breaker panel and an electrical generator electrically interfacing with the transfer switch.

12. The container of claim 1 wherein the container enclosure comprises an enclosure pad, a plurality of enclosure sidewalls on the enclosure pad, a plurality of enclosure corners joining adjacent ones of the plurality of enclosure sidewalls, an enclosure top on the plurality enclosure sidewalls and at least one enclosure door in at least one of the plurality of enclosure sidewalls.

13. A container, comprising:
a transportable container enclosure comprising:
an enclosure pad;
a plurality of enclosure sidewalls on the enclosure pad;
a plurality of enclosure corners joining adjacent ones of the plurality of enclosure sidewalls;
an enclosure top on the plurality enclosure sidewalls;
an enclosure interior and an enclosure exterior formed by the enclosure pad, the enclosure sidewalls and the enclosure top; and
at least one enclosure door in at least one of the plurality of enclosure sidewalls;
an electrical distribution system in the enclosure interior of the container enclosure, the electrical distribution system configured for electrical communication with the electrical current source and the at least one electric vehicle charging station, the electrical distribution system having at least one charging station transformer configured to step up voltage of the electrical current from a voltage of 120V at the electrical current source to a voltage of 480V and transmit the electrical current to the at least one electric vehicle charging station;
at least one ground bus bar electrically interfacing with the at least one charging station transformer;
a plurality of ground rods on the container enclosure and electrically interfacing with the at least one ground bus bar;
a ground ring electrically connecting the plurality of ground rods to each other, the ground ring configured for burial to ground the container enclosure;
a lighting control system comprising:
at least one enclosure lamp configured to illuminate at least one of the enclosure interior and the enclosure exterior of the container enclosure; and
at least one lamp control module on an exterior surface of the container enclosure, the lamp control module controllably interfacing with the at least one enclosure lamp;
a main breaker panel electrically interfacing with the electrical distribution system, the main breaker panel configured for electrical connection to the electrical current source; and
a transfer switch electrically interfacing with the main breaker panel; and
an electrical generator electrically interfacing with the transfer switch.

14. The container of claim 13 further comprising an electrical riser having an electrical current source electrically configured to electrically interface with the transfer switch and electric vehicle service equipment having at least one electric vehicle charging station configured to electrically interface with the at least one charging station transformer of the electrical distribution system.

15. The container of claim 14 further comprising a main disconnect switch electrically interfacing with the electrical current source and configured to electrically interface with the transfer switch.

16. A method of stepping up voltage of electrical current from an electrical current source to electric vehicle service equipment having at least one electric vehicle charging station at an electric vehicle charging facility, the method comprising:
fabricating a container at a manufacturing facility by constructing a container enclosure having an enclosure interior and an enclosure exterior;
assembling an electrical distribution system in the enclosure interior of the container enclosure, the electrical distribution system configured for electrical communication with the electrical current source and the at least one electric vehicle charging station, the electrical distribution system having at least one charging station transformer configured to step up voltage of the electrical current and transmit the electrical current to the at least one electric vehicle charging station;
transporting the container to the electric vehicle charging facility;
placing the container enclosure at a desired location of the electric vehicle charging facility;
electrically connecting the at least one charging station transformer of the electrical distribution system to the electrical current source; and
electrically connecting the at least one vehicle charging station of the electric vehicle charging facility to the at least one charging station transformer of the electrical distribution system.

17. The method of claim 16 wherein assembling the electrical distribution system having the at least one charging station transformer comprises assembling the electrical distribution system having the at least one charging station transformer configured to step up voltage of the electrical current from 120V to 480V.

18. The method of claim 16 further comprising providing a lighting control system comprising at least one enclosure lamp configured to illuminate at least one of the enclosure interior and the enclosure exterior of the container enclosure.

19. The method of claim 18 further comprising providing at least one lamp control module on an exterior surface of the container enclosure and controllably interfacing the at least one lamp control module with the at least one enclosure lamp.

20. The method of claim 19 wherein providing at least one lamp control module on the exterior surface of the container enclosure comprises providing a wall pack with a photocell on the exterior surface of the container enclosure, the at least one lamp control module configured to energize the at least one enclosure lamp responsive to darkening of an ambient environment of the container enclosure.
